(19) United States
(12) Patent Application Publication
(10) Pub. No.: US 2009/0230864 A1
(43) Pub. Date: Sep. 17, 2009

(54) COMPACT HID ARC LAMP HAVING SHROUDED ARC TUBE AND HELICAL LEAD WIRE

(75) Inventors: Joseph P. Woods, Hammondsport, NY (US); John S. Bailey, Bradford, NY (US); Joseph J. Carbone, Hornell, NY (US); William T. Solsky, Bath, NY (US); Junming Tu, Bath, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,016

(22) PCT Filed: Apr. 6, 2007
(86) PCT No.: PCT/IB07/51256

§ 371 Date: Oct. 30, 2008

(30) Foreign Application Priority Data
May 8, 2006 (US) 60746658

(51) Int. Cl. H01J 61/36

(52) U.S. Cl. 313/623

(57) ABSTRACT

A compact open-rated HID lamp (10) having a shrouded arc tube (12) positioned within a compact outer envelope (28), which lamp (9) has an arc tube mounting assembly (30) characterized by a long lead wire (32) which extends from the press seal (29) at the base end (28A) of the outer envelope (28), winds helically around the shroud (26) and extends into and is biased outwardly against the distal end (28B) of the outer envelope (28), thus not only conducting current to the distal electrode (24) of the arc tube (12), but also centering and supporting the retaining shroud (26) and supplementing the shroud's retainment function with minimal parts and minimal wire connections. In addition, arc displacement is minimized, leading to higher lumen maintenance and longer lifetimes.

This invention relates to a compact high intensity discharge (HID) arc lamp, and more particularly relates to such a lamp having a shrouded arc tube, and also relates to an improved arc tube mounting assembly for such a lamp.

HID arc lamps are known to be susceptible to arc bending, caused by magnetic forces set up by current-carrying support members. Such arc bending moves the arc closer to a sidewall of the arc discharge vessel, raising the temperature of the wall, and leading to shorter lamp life or even to catastrophic failure of the discharge vessel.

Patent Abstracts of Japan Publication number 55-105945 describes a high pressure vapor discharge lamp in which turbulence of the discharge arc caused by magnetic fields is said to be suppressed by surrounding the arc tube with a spiral winding of a reed stem wire.

United States Patent Application Publication 2003/0062831 provides special frame wire structures for stabilizing the arc of a ceramic HID lamp. In one embodiment, two identical frame wires run parallel to one another along opposite sides of and equidistant from the arc tube. The current load to the discharge electrode distal from the base of the lamp is shared by these frame wires. This arrangement is said to greatly reduce or eliminate detrimental interaction between the frame wires and the arc. In other embodiments, the frame wires are formed into helical coils which surround the arc tube.

In some HID lamp designs, the arc tube is surrounded by a cylindrically-shaped quartz shroud (see U.S. Pat. No. 5,402,033) or with a coiled antenna around a cylindrical ceramic arc-tube (see U.S. Pat. No. 6,861,805). These retainment devices improve the safety of the lamp in the event that the arc tube shatters, by allowing the lamp outer envelope to remain intact by dissipating the energy of a shattering arc tube.

The presence of a retainment device expands the market for metal halide lamps into open-type (absence of an expensive cover plate) lighting fixtures. Such lamps are sometimes referred to as ‘open-rated’ lamps.

U.S. Pat. No. 6,741,013 provides a shrouded ceramic discharge lamp said to have an easier and more cost efficient lamp construction. The non-insulated main conductor wire mechanically supports the shroud with upper and lower center supports. In some embodiments, a support wire has a central helical portion which encircles or surrounds the shroud and is attached to the main conductor wire.

European Patent 0 186 899 B1 provides a lamp with a shrouded quartz arc tube and a single wire frame member having a helical portion which surrounds and supports the shroud.

All of the above lamp constructions, whether shrouded or not, are characterized by relatively large outer glass envelopes having a stem at the base end and a large dimple at the distal end, and a mounting assembly which is sealed into the stem at the base end and is attached to and/or supported by the dimple at the distal end.

There is presently being considered for commercial manufacture a class of compact open-rated HID lamps having wattages from about 150 watts to about 400 watts and a voltage nominally rated at 100 volts, which are containment-safe for open-rated fixtures due to the employment of a quartz shroud around the arc tube.

Such compact open-rated HID lamps have a relatively compact outer glass envelope which lacks both the stem and the dimple of larger HID lamps. Thus, the various arc tube mounting arrangements of the prior art described above are not applicable to these compact lamp designs.

In these compact open-rated designs, current is supplied to the distal electrode of the arc tube with a straight lead wire parallel to the arc-tube axis of the lamp. Due to the smaller distance between the lead wire and the arc that is present in compact lamps, magnetic fields from the lead wire tend to induce arc displacement from the arc-tube axis, which displacement increases with the higher currents of the higher wattage lamps.

As is known, the displacement of the arc from the center of the arc-tube locally increases arc tube wall temperatures, creating thermal stresses across the arc-tube wall that lead to shorter lifetime. The displaced arc also creates an asymmetric flow pattern of the gases in the arc-tube that causes wall blackening and lower lumen maintenance. Thus, a centered arc will have higher lumen maintenance and longer lifetimes.

There is a need for an arc tube mounting assembly for these compact ‘open rated’ HID lamps which is both simple and compact, and which does not contribute to displacement of the arc.

According to the invention, there is provided a compact open-rated HID lamp having a shrouded arc tube positioned within a compact outer envelope, which lamp has an arc tube mounting assembly characterized by a long lead wire which extends from the press seal at the base end of the outer envelope, winds helically around the shroud and extends into and is biased outwardly against the distal end of the outer envelope, thus not only conducting current to the distal electrode of the arc-tube, but also centering and supporting the retaining shroud and supplementing the shroud's retainment function with minimal parts and minimal wire connections.

In addition, the helical configuration realigns the magnetic field of the main lead wire and removes the magnetic force that displaces the arc from the centerline of the arc-tube, resulting in improved lumen maintenance and longer lifetimes.

According to one aspect of the invention, a compact open-rated HID lamp is provided comprising:

an arc tube having a central body portion enclosing a discharge space, a base end and a distal end arranged at opposite ends of the discharge space;

a base discharge electrode and a distal discharge electrode extending into opposite ends of the discharge space through the base end and the distal end, respectively;

a retainment shroud surrounding the arc tube and having a base end and a distal end;

an outer envelope enclosing the arc tube, the discharge electrodes and the shroud; the outer envelope having a base end with a press seal and a distal end (28B);

a short lead wire electrically connected to the base discharge electrode and a long lead wire electrically connected to the distal discharge electrode;

wherein the long lead wire comprises a base portion extending from the press seal to the base end of the shroud, a central helical portion surrounding the shroud, and a distal portion extending from the distal end of shroud (26) into and biased outwardly against the distal end of the envelope.

According to a preferred embodiment of the invention, the base portion of the long lead wire comprises an inclined portion which extends toward the wall of the envelope, and a first straight portion which extends along the wall of the envelope substantially parallel to the central axis A.

According to another preferred embodiment of the invention, the distal portion of the long lead wire comprises a second straight portion which extends along the wall of the envelope substantially parallel to the central axis A.

According to yet another preferred embodiment of the invention, the distal end of the outer lamp envelope has a curvature, and the distal portion of the long lead wire comprises a portion having a curvature conforming at least substantially to the curvature of the distal end of the envelope.

According to yet another preferred embodiment of the invention, the envelope has a cylindrically-shaped body portion.

According to another aspect of the invention, a mounting assembly for a compact open-rated HID lamp comprises:

an arc tube having a central body portion enclosing a discharge space, a base end and a distal end arranged at opposite ends of the discharge space;

a base discharge electrode and a distal discharge electrode extending into opposite ends of the discharge space through the base end and the distal end, respectively;

a retainment shroud surrounding the arc tube;

a short lead wire electrically connected to the base discharge electrode and a long lead wire electrically connected to the distal discharge electrode;

wherein the long lead wire comprises a base portion adapted to extend from the press seal of an outer lamp envelope to the base end of the shroud, a central helical portion surrounding the shroud, and a distal portion adapted to extend from the distal end of the shroud into and bias outwardly against the distal end of an outer lamp envelope.

According to a preferred embodiment of this aspect of the invention, the base portion of the long lead wire comprises an inclined portion adapted to extend toward the wall of the outer lamp envelope, and a first straight portion adapted to extend along the wall of the envelope substantially parallel to the central axis A.

According to another preferred embodiment of this aspect of the invention, the distal portion of the long lead wire comprises a second straight portion adapted to extend along the wall of the envelope substantially parallel to the central axis A.

According to yet another preferred embodiment of this aspect of the invention, the distal end of the outer lamp envelope has a curvature, and the distal portion of the long lead wire comprises a portion having a curvature adapted to conform at least substantially to the curvature of the distal end of the envelope.

According to a still further preferred embodiment of this aspect of the invention, the distal portion of the long lead wire comprises a third straight portion connected to the second straight portion by a first curved portion and a fourth straight portion connected to the third straight portion by a second curved portion.

According to a still further preferred embodiment of this aspect of the invention, the helical portion is connected to the first straight portion by a first bent portion, and the helical portion is connected to the second straight portion by a second bent portion, the bent portions functioning as stops to prevent lateral slippage of the shroud.

These and other aspects of the invention will be further elucidated with reference to the Figures, in which:

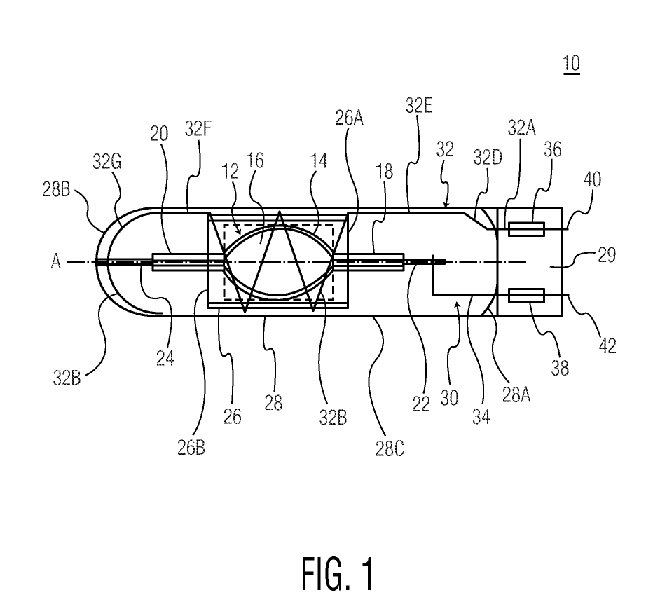

FIG. 1 is a schematic illustration of one embodiment of a compact open-rated HID lamp of the invention;

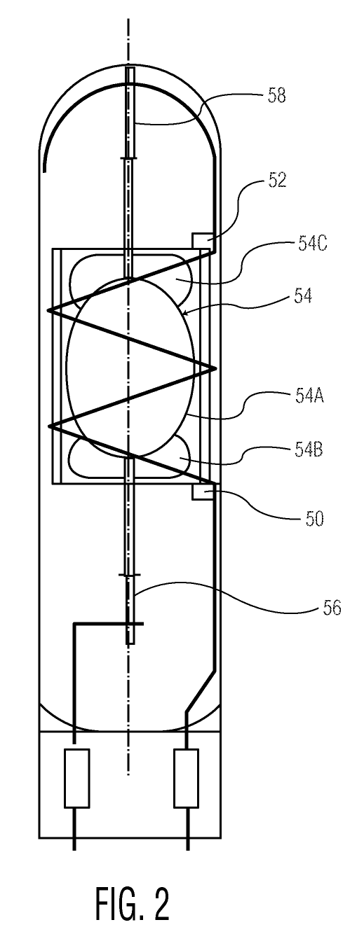

FIG. 2 is a schematic illustration similar to that of FIG. 1, for another embodiment of the invention; and

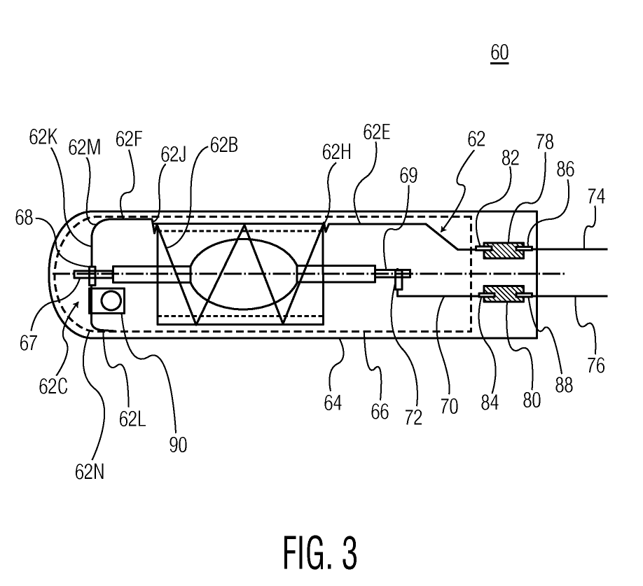

FIG. 3 is a schematic illustration of yet another embodiment of the invention.

The Figures are diagrammatic and not necessarily drawn to scale.

Compact HID lamps are so classified since the outer diameter of the outer bulb is substantially smaller than HID lamps of similar wattage. Single-ended lamps contain two lead wires in one end of the lamp and one lead must conduct current to the distal electrode of the arc-tube. In a standard configuration with the conductor to the distal electrode extending parallel to the axis of the arc-tube, the arc-discharge is subject to a force directed away from the single lead wire due to the magnetic field of the current carrying long lead. The repelling force acting on the discharge increases as the square of the lamp current and increases as the inverse of the distance between the lead wire and the arc-discharge. This force is substantially higher in compact lamps in which the single lead wire is in closer proximity to the arc-discharge and in higher wattage lamps in which the lamp current is substantially higher. The displacement of the discharge from the central axis of the arc-tube reduces lumen maintenance and creates thermal stress in the arc-tube wall that leads to shorter lamp lifetime.

In the compact, open-rated HID lamp of the invention, the long lead wire forms a helix around the shroud. This construction serves to secure the shroud in place, improves the containment properties of the shroud, and realigns the magnetic field of the current carrying lead and does not force displacement of the discharge from the center of the discharge. The magnetic field of the helical geometry is along the axis of the arc-tube that creates precession of charge particles about the central axis as opposed to the repelling force of the single lead wire.

One embodiment of such a lamp 10 is shown in FIG. 1, in which an arc tube 12 with an axis A has a body portion 14 enclosing a discharge space 16 filled with discharge-sustaining materials. A pair of discharge electrodes 22 and 24 extend into opposite ends of the discharge space 16 through base and distal ends 18 and 20 via extended plugs 19 and 21. The electrodes 22 and 24 are sealed into the extended plugs 19 and 21, so as to insure that the discharge space 16 is gas-tight.

The arc tube 12 and extended plugs 19 and 21 are preferably fabricated from polycrystalline alumina (PCA), but could also be fabricated from fused quartz.

The discharge-sustaining materials in the discharge space 16 are typically mercury, a rare gas and one or more metal halides, e.g., sodium iodide, calcium iodide and one or more rare earth iodides, or in the case of a fused quartz arc tube, sodium iodide, calcium iodide and scandium iodide.

Surrounding the arc tube 12 and concentrically with respect to axis A is a cylindrically-shaped, open-ended quartz retainment shroud 26, whose function is to prevent pieces of the arc tube from flying outward in the event of a rupture of the arc tube.

Surrounding the arc tube 12 and shroud 26 is an outer glass envelope 28, typically of fused quartz, having a base portion 28A, a distal dome-shaped portion 28B, and a cylindrical body portion 28C. A press seal 29 at the base end 28A forms a gas-tight enclosure, which is typically held in vacuum, but may be filled with a small amount, e.g., ½ to ⅓ atm., of an inert gas such as nitrogen, in order to reduce the operating temperature of the arc tube, particularly at higher wattages.

Typical outer diameters for the arc tube, shroud and outer envelope for such a compact, open-rated HID lamp increase with increasing wattage from about 5 mm, 10 mm and 14 mm, respectively, for a 20 watt lamp, ranging up to 19 mm, 28 mm and 35 mm, respectively, for a 400 watt lamp.

The arc tube 12 is supported within the outer envelope 28 by a short lead 34 and a long lead 32, which leads also supply power to the base discharge electrode 22 and the distal discharge electrode 24, respectively, via molybdenum foils 36 and 38 and external leads 40 and 42.

Molybdenum foils 36 and 38 are relatively thin and may have tapered edges to help to assure that the press seal forms a gas-tight seal.

In addition to supporting the arc tube 12 and supplying power to the distal discharge electrode 24, the long lead 32 has a helical portion 32B which surrounds and supports the shroud 26. Although shown to have two turns in this embodiment, one turn is sufficient for support of the shroud, while two turns is adequate for containment. While three or more turns are possible, more turns will reduce the lumen output from the arc tube. This can be compensated somewhat by reducing the wire diameter of the turns, so long as such reduction does not unduly weaken the support of the shroud 26. In the embodiment shown, the long lead has a wire diameter of about 0.76 mm, although this could vary within the range of about 0.55 mm to 0.90 mm, below which the wire lacks sufficient rigidity to survive a routine drop test, and above which the lumen output is undesirably reduced.

FIG. 2 shows another embodiment of an arc tube, in the form of a fused quartz arc tube 54, having a body 54A, and a pair of end seals 54B and 54C, through which extend discharge electrodes 56 and 58. Other elements are as shown in FIG. 1.

Additional support for the shroud 26 may be provided, if desired. FIG. 2 shows such additional support schematically in the form of stops 50 and 52 at the base end 26A and distal end 26B, respectively, of the shroud 26. These stops 50 and 52 are attached to the long lead 32, e.g., by spot welding.

The long lead 32 is advantageously fabricated from a heat-resistant electrically conducting material having spring properties, preferably molybdenum, but other materials could also be used, e.g., tantalum, tungsten, niobium and their alloys are also possible. The distal end 32C of the long lead 32 is shaped and dimensioned to force fit into the distal end 28B of the envelope 28, thereby resulting in an outward spring bias of the distal end 32C against the inner wall of the envelope 28, which serves to center and support the arc tube 12 and shroud 26 within the outer envelope. In the embodiment shown, distal end 32C has a portion 32G with a curvature which approximates the curvature of the dome-shaped distal end 28B of the envelope 28. This allows distal end 32C to fit closely against the distal end 28B, thus enhancing the compactness of the design.

Additional stability is provided by straight portions 32E and 32F of long lead 32, which straight portions contact the sidewall of the envelope 28. In addition, the straight portion 32F is forced against the sidewall by spring bias. Preferably, the helical portion has a slightly smaller diameter than that of the shroud, so that it wraps tightly around the shroud and exerts a compressive force on the shroud.

The foils 36 and 38 and the external leads 40 and 42 are also preferably fabricated of molybdenum, but could also be of any sufficiently heat-resistant and electrically conductive material, such as tantalum, tungsten, niobium and their alloys.

FIG. 3 shows another embodiment 60 of the compact open-rated HID lamp of the invention, in which long lead 62 in which the transition area between the helical portion 62B and the distal portion 62C, and the transition area between the helical portion 62B and the straight portion 62E is defined by bends 62H and 62J which function as stops to prevent shroud from sliding laterally within helical portion 62B. Distal portion 62C of long lead 62 is characterized by straight portions 62K and 62L and curved portions 62M and 62N. Straight portions 62F and 62L press outwardly against the inner wall 66 of outer envelope 64 due to the spring bias of the long lead 62. As will be appreciated, straight portions 62K and 62L need not be straight, but could have a slight curvature.

Typical outer diameters of the quartz shroud and the quartz outer envelope are 28 mm and 35 mm, respectively.

Electrodes 67 and 69 are attached to long lead 62 and short lead 70 via electrically conductive transition elements 68 and 72, respectively. Molybdenum foils 78 and 80 are attached to the long lead 62, the short lead 70, and the external leads 74 and 76 via electrically conductive transition elements 82-88. These transition elements act as flux materials to aid in the formation of welds with the molybdenum leads and foils, and may be, e.g., Nb or Ta.

The invention has necessarily been described in terms of a limited number of embodiments. From this description, other embodiments and variations of embodiments will become apparent to those skilled in the art, and are intended to be fully encompassed within the scope of the invention and the appended claims.

1. A compact open-rated HID lamp (10) comprising:
an arc tube (12) having a central body portion (14) enclosing a discharge space (16), a base end (18) and a distal end (20) arranged at opposite ends of the discharge space;
a base discharge electrode (22) and a distal discharge electrode (24) extending into opposite ends of the discharge space (16) through the base end (18) and the distal end (20), respectively;
a retainment shroud (26) surrounding the arc tube (12) and having a base end (26A) and a distal end (26B);
an outer envelope (28) enclosing the arc tube (12), the discharge electrodes (22, 24) and the shroud (26); the outer envelope having a base end (28A) with a press seal (29) and a distal end (28B);
a short lead wire (34) electrically connected to the base discharge electrode (22) and a long lead wire (32) electrically connected to the distal discharge electrode (24);
wherein the long lead wire (32) comprises a base portion (32A) extending from the press seal (29) to the base end (26A) of the shroud (26), a central helical portion (32B) surrounding the shroud (26), and a distal portion (32C) extending from the distal end (26B) of shroud (26) into and biased outwardly against the distal end (28B) of the envelope (28).

2. The compact open-rated HID lamp (10) of claim 1, in which the base portion (32A) of the long lead wire (32) comprises an inclined portion (32D) which extends toward the wall of the envelope (28), and a straight portion (32E) which extends along the wall of the envelope (28).

3. The compact open-rated HID lamp (10) of claim 1, in which the distal portion (32C) of the long lead wire (32) comprises a straight portion (32F) which extends along the wall of the envelope (28).

4. The compact open-rated HID lamp (10) of claim 1, in which the distal end (28B) of the envelope (28) has a curvature, and the distal portion (32C) of the long lead wire (32) comprises a portion (32G) having a curvature conforming at least substantially to the curvature of the distal end (28B) of the envelope (28).

5. The compact open-rated HID lamp (10) of claim 1, in which the envelope (28) has a cylindrically-shaped body portion (28C).

6. The compact open-rated HID lamp (10) of claim 1, in which first and second electrically conducting foils (36, 38) are present in the press seal (29), and the long lead wire (32) and the short lead wire (34) extend into the press seal (29) and are electrically connected to the first and second electrically conducting foils (36, 38), respectively.

7. The compact open-rated HID lamp (10) of claim 6, in which first and second exterior leads (40, 42) extend into the press seal (29) and are electrically connected to the first and second electrically conducting foils (36, 38), respectively.

8. The compact open-rated HID lamp (10) of claim 1, in which the helical portion (32B) of the long lead (32) comprises from one to three turns.

9. The compact open-rated HID lamp (10) of claim 8, in which the long lead (32) has a wire diameter within the range of about 0.55 mm to 0.90 mm.

10. The compact open-rated HID lamp (10) of claim 2 in which the straight portion (32E) extends substantially parallel to the long axis A of the lamp.

11. The compact open-rated HID lamp (10) of claim 3 in which the straight portion (32F) extends substantially parallel to the long axis A of the lamp.

12. A mounting assembly (30) for a compact open-rated HID lamp (10), the mounting assembly comprising:
an arc tube (12) having a central body portion (14) enclosing a discharge space (16), a base end (18) and a distal end (20) arranged at opposite ends of the discharge space;
a base discharge electrode (22) and a distal discharge electrode (24) extending into opposite ends of the discharge space (16) through the base end (18) and the distal end (20), respectively;
a retainment shroud (26) surrounding the arc tube (12);
a short lead wire (34) electrically connected to the base discharge electrode (22) and a long lead wire (32) electrically connected to the distal discharge electrode (24);
wherein the long lead wire (32) comprises a base portion (32A) adapted to extend from the press seal (29) of an outer lamp envelope (28) to the base end (26A) of the shroud (26), a central helical portion (32B) surrounding the shroud (26), and a distal portion (32C) adapted to extend from the distal end (26B) of the shroud (26) into and bias outwardly against the distal end (28B) of an outer lamp envelope (28).

13. The mounting assembly (30) of claim 12, in which the base portion (32A) of the long lead wire (32) comprises an inclined portion (32D) adapted to extend toward the wall of the outer lamp envelope (28), and a first straight portion (32E) adapted to extend along the wall of the envelope (28).

14. The mounting assembly (30) of claim 12, in which the distal portion (32C) of the long lead wire (32) comprises a second straight portion (32F) adapted to extend along the wall of the envelope (28).

15. The mounting assembly (30) of claim 12, in which the distal portion (32C) of the long lead wire (32) comprises a portion (32G) having a curvature adapted to conform at least substantially to the curvature of the distal end (28B) of an outer lamp envelope (28).

16. The mounting assembly (60) of claim 14, in which the distal portion (62C) of the long lead wire (62) comrises a third straight portion (62K) connected to the second straight portion (62F) by a first curved portion (62M) and a fourth straight portion (62L) connected to the third straight portion (62K) by a second curved portion (62N).

17. The mounting assembly (60) of claim 14, in which the helical portion (62B) is connected to the first straight portion (62E) by a first bent portion (62H), and the helical portion (62B) is connected to the second straight portion (62F) by a second bent portion (62J).

18. The mounting assembly (30) of claim 12, in which the helical portion (32B) of the long lead (32) comprises from one to three turns.

19. The mounting assembly (30) of claim 18, in which the long lead (32) has a wire diameter within the range of about 0.55 mm to 0.90 mm.

20. The mounting assembly (60) of claim 16 in which the distal electrode (67) and the base electrode (69) are attached to the long lead (62) and the short lead (70), respectively, by transition elements (68, 72).
